(19) United States
(12) Patent Application Publication
(10) Pub. No.: US 2008/0046367 A1
(43) Pub. Date: Feb. 21, 2008

(54) Mobile device confirmation of transactions

(75) Inventors: James A. Billmaier, Woodinville, WA (US); David P. Billmaier, Woodinville, WA (US); John M. Kellum, Woodinville, WA (US)

Correspondence Address: FSP LLC, P.O. BOX 890, VANCOUVER, WA, 98666, US

(73) Assignee: Patent Navigation Inc., Woodinville, WA (US)

(21) Appl. No.: 11/893,953

(22) Filed: Aug. 17, 2007

Related U.S. Application Data
(60) Provisional application No. 60/838,598, filed on Aug. 18, 2006.

(51) Int. Cl. G06Q 40/00

(52) U.S. Cl. 705/44

(57) ABSTRACT

Authenticating/authorizing a transaction may include and/or involve detecting a location of a person, detecting a location of a transaction associated with the person, and signaling a communication device carried by the person when the location of the person and the location of the transaction are substantially different.

### PRIORITY

This application claims priority to U.S. provisional patent application MOBILE DEVICE CONFIRMATION OF TRANSACTIONS, having application No. 60/838,598, filed on Friday, Aug. 18, 2006.

### TECHNICAL FIELD

The present disclosure relates to transaction confirmation.

### BACKGROUND

A major problem today is theft of credit and/or debit facilities, resulting in unauthorized transactions. For example, if someone loses their wallet and credit cards, the cards may be found and used by unauthorized persons.

Deterrent and prevention of unauthorized transactions is thus an important area of endeavor.

### SUMMARY

The following summary is intended to highlight and introduce some aspects of the disclosed embodiments, but not to limit the scope of the claims. Thereafter, a detailed description of illustrated embodiments is presented, which will permit one skilled in the relevant art to make and use various embodiments.

Authenticating and/or authorizing a transaction may include and/or involve detecting a location of a person, and signaling a communication device carried by the person to request confirmation of a transaction, for example via a short text message identifying the transaction to the communication device. Notification of the transaction may also occur by paging the person, and/or instant messaging the person. The communication device may include a cell phone, pager, personal digital assistant, laptop, palmtop, sub-notebook, or wearable computer.

A return message from the communication device may be requested as confirmation that the transaction should proceed. The return message may include a password or other authenticating information as confirmation that the transaction should proceed.

In some implementations, authenticating/authorizing a transaction may include and/or involve detecting a location of a person, detecting a location of a transaction associated with the person, and signaling a communication device carried by the person when the location of the person and the location of the transaction are substantially different. Detecting a transaction location may involve detecting a store location of a credit card or debit card transaction, and/or detecting an IP address location of a terminal involved in an online transaction. Detecting the location of the person may involve detecting a wireless signal produced by the communication device carried by the person, and may involve detecting the location of a wireless cellular telephone signal, and/or detecting the location of a GPS signal produced by the communication device, and/or detecting the location of a nearby wireless hotspot with which the communication device is in communication.

Other system/method/apparatus aspects are described in the text (e.g., detailed description and claims) and drawings forming the present application.

### BRIEF DESCRIPTION OF THE DRAWINGS

In the drawings, the same reference numbers and acronyms identify elements or acts with the same or similar functionality for ease of understanding and convenience. To easily identify the discussion of any particular element or act, the most significant digit or digits in a reference number refer to the figure number in which that element is first introduced.

FIG. 1 is a block diagram of an embodiment of a transaction environment.

FIG. 2 is an action flow diagram of an embodiment of a process of authenticating and authorizing a transaction.

### DETAILED DESCRIPTION

References to “one embodiment” or “an embodiment” do not necessarily refer to the same embodiment, although they may.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list.

“Logic” refers to signals and/or information that may be applied to influence the operation of a device. Software, hardware, and firmware are examples of logic. Hardware logic may be embodied in circuits. In general, logic may comprise combinations of software, hardware, and/or firmware.

Transaction Environment

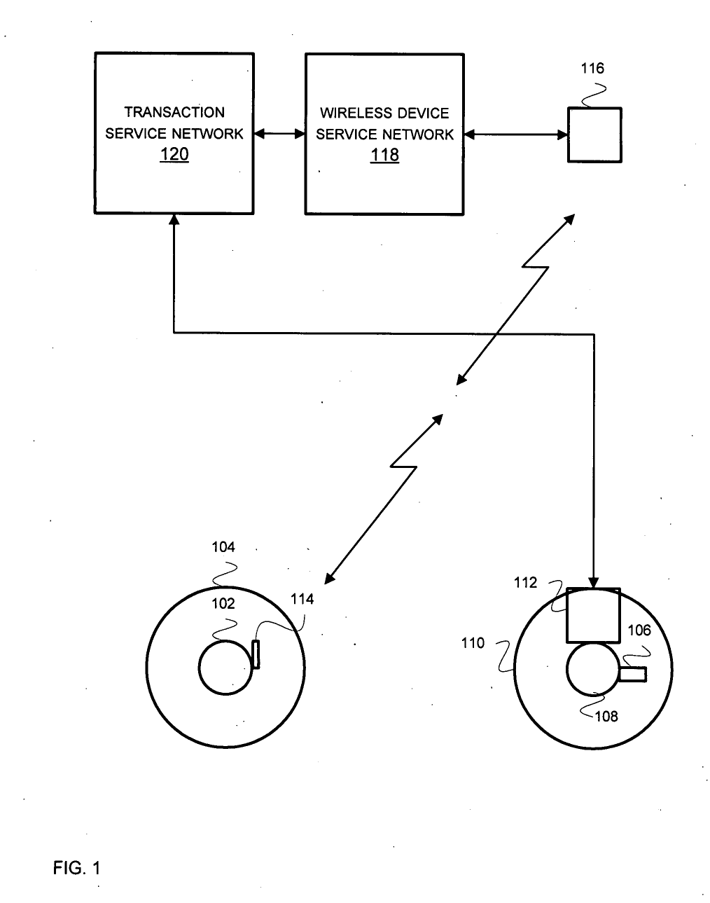

FIG. 1 is a block diagram of an embodiment of a transaction environment. The environment may include, but may not be limited to, an authorized individual 102, a location of the authorized individual 104, a transaction mechanism 106, an unauthorized individual 108, a location 110 of a transaction involving the transaction mechanism 106, a point of sale 112, a portable communication device 114, a wireless access point 116, a wireless device service network 118, and a transaction service network 120. Other elements and/or couplings among the elements have been omitted as they would be apparent to skilled practitioners in the relevant art(s).

The authorized individual 102 is an individual authorized to use the transaction mechanism 106, such as, for example, one or more owner and/or authorized user of a credit and/or debit card. The location of the authorized individual 104 is an approximate location, such as, for example, a retail establishment in a different part of town or a different block or down the street from the location 110 of a transaction involving the transaction mechanism 106.

The transaction mechanism 106 is a portable mechanism to provide access to money and/or credit of the authorized individual 102, such as, for example, one or more credit card, debit card, stored value card, or smart card. The term ‘smart card’, as used herein, refers to a card, typically carried in the wallet, comprising processing and memory circuits. The transaction mechanism 106 may presented at a point of sale 112 and processed to cause a debit from the authorized individual 102’s account, and/or access to credit of the authorized individual 102, and/or access and deduct from stored value of the transaction mechanism 106.

The unauthorized individual 108 is an individual who is not authorized to use the transaction mechanism 106, such as, for example, a person who stole or found a credit or debit card that does not belong to them, or who obtained the authentication-authorization information for such a card through unauthorized means.

The location 110 of a transaction involving the transaction mechanism 106 is typically the approximate location of the point of sale 112, such as, for example, a retail establishment in a different part of town or a different block or down the street from the location of the authorized individual 104. The point of sale 112 comprises equipment and/or person(s) to which the transaction mechanism 106 is presented and processed to cause a debit from the authorized individual 102's account, and/or access to credit of the authorized individual 102, and/or access and deduct from stored value of the transaction mechanism 106. Examples are a card reader, and/or a debit card terminal at a checkout counter.

The portable communication device 114 is a wireless communication device that accompanies the authorized individual 102 and/or a vehicle of the authorized individual 102. Such devices may include one or more cell phone, pager, personal digital assistant, or portable computer of various form factors. The portable communication device 114 may be in wireless communication with one or more wireless access points 116. The wireless access point 116 provides the portable communication device 114 with wireless access to one or more wireless device service networks 118. Examples of wireless access points 116 include one or more cell phone and/or paging towers, GPS satellites, and/or shorter-range wireless ‘hotspots’ such as Wi-Fi or Bluetooth. The term ‘GPS’, as used herein, refers to well-known global positioning system technologies, typically satellites in geosynchronous orbit. The wireless device service network 118 is an equipment network providing access, authentication, authorization, and routing of information for the portable communication device 114. Examples include one or more cell phone service networks, GPS service networks, and/or computer networks such as the Internet, LAN, or MAN. The term ‘LAN’, as used herein, refers to ‘local area network’. ‘MAN’ refers to ‘metropolitan area network’.

The transaction service network 120 includes equipment providing access, authentication, authorization, and routing of information for equipment of the point of sale 112. Examples include the banking network of VISA, Master Charge, Discover, and/or American Express.

Other examples and/or embodiments of the transaction mechanism 106, point of sale 112, portable communication device 114, wireless access point 116, wireless device service network 118, and transaction service network 120 may be apparent to skilled practitioners in the relevant art(s).

Authentication and/or Authorization

To improve authentication/authorization of transactions and help prevent fraud, a communication device 114 carried by the person 102 may be signaled to request confirmation of a transaction involving a transaction mechanism 106 associated with the person.

In one embodiment, this may involve communicating a short text message identifying the transaction to the communication device 114. The person 102 may then authorize the transaction via the communication device 114, or deny authorization if the transaction is fraudulent.

Thus, in some embodiments, a return message from the communication device 114 may be requested as confirmation that the transaction should proceed. The request may be for a return message including a password or other authenticating information as confirmation that the transaction should proceed.

As previously noted, the communication device 114 could be, for example, a cell phone, pager, personal digital assistant, laptop, palmtop, sub-notebook, or wearable computer.

Location Detection

Determining the location 104 of the authorized person 102 may involve detecting the location of a wireless signal produced by the communication device 114 carried by the person. This may involve, for example, detecting the location of a wireless cellular telephone signal, detecting the location of a GPS signal produced by the communication device, or detecting the location of a nearby wireless hotspot with which the communication device is in communication.

In one embodiment, location detection may be employed to assist with authentication/authorization of transactions. For example, one application may involve detecting the location 104 of the authorized person 102, detecting the location 110 of a transaction associated with the person 102, and signaling a communication device 114 carried by the person 102 when the location 104 of the person 102 and the location 110 of the transaction are substantially different.

Detecting the location 110 of a transaction associated with the person 102 may involve, for example, detecting a store location of a credit card or debit card transaction, or detecting an IP address location of a terminal involved in an online transaction.

Other Manners of Notification

Although text messaging has been mentioned as a manner of notifying the authorized person 102 of a transaction, other manners of notification are also possible. These include, but are not limited to, paging the person 102 and instant messaging the person 102.

Process of Authenticating and Authorizing a Transaction

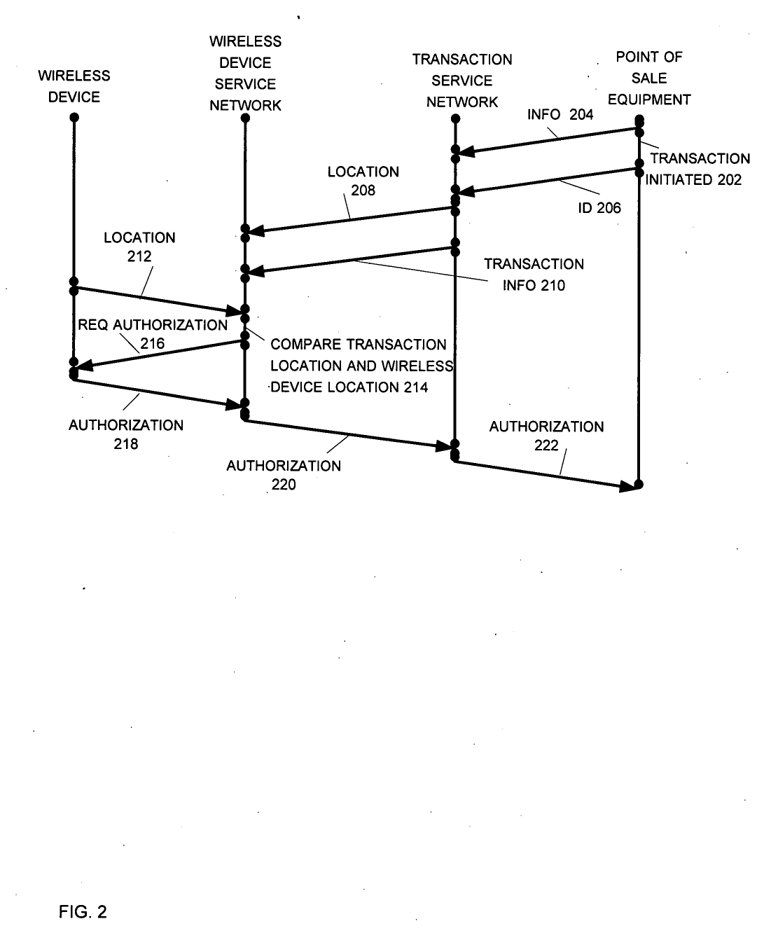

FIG. 2 is an action flow diagram of an embodiment of a process of authenticating and authorizing a transaction.

At 202 a transaction is initiated at the point of sale equipment. The transaction may be initiated by an authorized person, or by a person who obtained the transaction mechanism or numbers or codes thereof by unauthorized means.

To help prevent unauthorized use of the transaction mechanism, at 204 the point of sale equipment provides transaction information (such as a credit card number and the amount of the transaction) to the transaction service network. The point of sale equipment may also provide a point of sale id to the transaction service network at 206. This id may prove useful in identifying the location of the transaction.

The transaction service network determines the location of the transaction, and at 208 provides the location to the wireless device service network. At 210 the transaction service network also provides transaction information (e.g. the amount of the transaction, location of the transaction, etc.) to the wireless device service network.

At 212 the wireless device provides location information for the wireless device to the wireless device service network. Of course, the location information may be obtained by many means, for example, by cellular triangulation, identifying a nearby wireless hotspot, and so on. In many cases, the location information may be provided from sources other than the wireless device.

At 214 the wireless device service network compares the transaction location with the wireless device location 214. Of course, this comparison could instead or additionally be performed by the transaction service network. In some cases, this comparison may not take place at all.

At 216 the wireless device service network requests authorization of the transaction from the wireless device. At 218 the wireless device provides this authorization to wireless device service network. The authorization may take the form of simply acknowledging the transaction via a text message, or may be more sophisticated and involve the communication of authenticating/authorizing information (PINs, passwords, etc.) to the wireless service network.

At 220 the wireless device service network provides authorization of the transaction to the transaction service network, and at 222 the transaction service network provides authorization of the transaction to the point of sale equipment.

In some embodiments, the location of a transaction associated with the person is detected, and if the location of the person and the location of the transaction are substantially the same, the transaction is considered valid (unless other factors indicate otherwise). If the location of the person and the location of the transaction are substantially different, the person's mobile device may be signaled concerning the transaction and a confirmation of the transaction requested from the mobile device. Also or alternatively, a point of sale where the transaction is occurring may be signaled when the mobile device is not substantially co-located with the transaction, indicating that additional authenticating information should be obtained from the person attempting the purchase before the transaction is confirmed.

Those having skill in the art will appreciate that there are various vehicles by which processes and/or systems described herein can be effected (e.g., hardware, software, and/or firmware), and that the preferred vehicle will vary with the context in which the processes are deployed. For example, if an implementer determines that speed and accuracy are paramount, the implementer may opt for a hardware and/or firmware vehicle; alternatively, if flexibility is paramount, the implementer may opt for a solely software implementation; or, yet again alternatively, the implementer may opt for some combination of hardware, software, and/or firmware. Hence, there are several possible vehicles by which the processes described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations may involve optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood as notorious by those within the art that each function and/or operation within such block diagrams, flowcharts, or examples can be implemented, individually and/or collectively, by a wide range of hardware, software, firmware, or virtually any combination thereof. Several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in standard integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment).

Those skilled in the art will recognize that it is common within the art to describe devices and/or processes in the fashion set forth herein, and thereafter use standard engineering practices to integrate such described devices and/or processes into larger systems. That is, at least a portion of the devices and/or processes described herein can be integrated into a network processing system via a reasonable amount of experimentation.

The foregoing described aspects depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality.

What is claimed is:

1. A process of authenticating and/or authorizing a transaction comprising:
signaling a communication device carried by the person to request confirmation of the transaction.

2. The process of authenticating and/or authorizing a transaction of claim 1, wherein signaling a communication device carried by the person further comprises:
communicating a short text message identifying the transaction to the communication device.

3. The process of authenticating and/or authorizing a transaction of claim 2, wherein communicating a short text message identifying the transaction to the communication device further comprises:
communicating to the communication device a short text message identifying the transaction and requesting a return message as confirmation that the transaction should proceed.

4. The process of authenticating and/or authorizing a transaction of claim 3, wherein communicating to the communication device a short text message identifying the transaction and requesting a return message as confirmation that the transaction should proceed further comprises:
communicating to the communication device a short text message identifying the transaction and requesting a return message comprising a password or other authenticating information as confirmation that the transaction should proceed.

5. The process of authenticating and/or authorizing a transaction of claim 1, further comprising:
detecting the location of a wireless signal produced by the communication device carried by the person.

6. The process of authenticating and/or authorizing a transaction of claim 5, wherein detecting the location of a wireless signal produced by the communication device carried by the person further comprises:
detecting the location of a wireless cellular telephone signal.

7. The process of authenticating and/or authorizing a transaction of claim 5, wherein detecting the location of a wireless signal produced by the communication device carried by the person further comprises:
detecting the location of a GPS signal produced by the communication device.

8. The process of authenticating and/or authorizing a transaction of claim 5, wherein detecting the location of a wireless signal produced by the communication device carried by the person further comprises:
detecting the location of a nearby wireless hotspot with which the communication device is in communication.

9. The process of authenticating and/or authorizing a transaction of claim 1, wherein signaling a communication device carried by the person further comprises:
paging the person.

10. The process of authenticating and/or authorizing a transaction of claim 1, wherein signaling a communication device carried by the person further comprises:
instant messaging the person.

11. The process of authenticating and/or authorizing a transaction of claim 1, wherein the communication device carried by the person further comprises:
one of a cell phone, pager, personal digital assistant, laptop, palmtop, sub-notebook, or wearable computer.

12. A process of authenticating and/or authorizing a transaction comprising:
detecting a location of a person;
detecting a location of a transaction associated with the person; and
signaling a communication device carried by the person when the location of the person and the location of the transaction are substantially different.

13. The process of authenticating and/or authorizing a transaction of claim 12, wherein signaling a communication device carried by the person further comprises:
communicating a short text message identifying the transaction to the communication device.

14. The process of authenticating and/or authorizing a transaction of claim 13, wherein communicating a short text message identifying the transaction to the communication device further comprises:
communicating to the communication device a short text message identifying the transaction and requesting a return message as confirmation that the transaction should proceed.

15. The process of authenticating and/or authorizing a transaction of claim 14, wherein communicating to the communication device a short text message identifying the transaction and requesting a return message as confirmation that the transaction should proceed further comprises:
communicating to the communication device a short text message identifying the transaction and requesting a return message comprising a password or other authenticating information as confirmation that the transaction should proceed.

16. The process of authenticating and/or authorizing a transaction of claim 12, wherein detecting a location of a person further comprises:
detecting the location of a wireless signal produced by the communication device carried by the person.

17. The process of authenticating and/or authorizing a transaction of claim 16, wherein detecting the location of a wireless signal produced by the communication device carried by the person further comprises:
detecting the location of a wireless cellular telephone signal.

18. The process of authenticating and/or authorizing a transaction of claim 16, wherein detecting the location of a wireless signal produced by the communication device carried by the person further comprises:
detecting the location of a GPS signal produced by the communication device.

19. The process of authenticating and/or authorizing a transaction of claim 16, wherein detecting the location of a wireless signal produced by the communication device carried by the person further comprises:
detecting the location of a nearby wireless hotspot with which the communication device is in communication.

20. The process of authenticating and/or authorizing a transaction of claim 12, wherein detecting a location of a transaction associated with the person further comprises:
detecting a store location of a credit card or debit card transaction.

21. The process of authenticating and/or authorizing a transaction of claim 12, wherein detecting a location of a transaction associated with the person further comprises:
detecting an IP address location of a terminal involved in an online transaction.

22. The process of authenticating and/or authorizing a transaction of claim 12, wherein signaling a communication device carried by the person further comprises:
paging the person.

23. The process of authenticating and/or authorizing a transaction of claim 12, wherein signaling a communication device carried by the person further comprises:
instant messaging the person.

24. The process of authenticating and/or authorizing a transaction of claim 12, wherein the communication device carried by the person further comprises:
one of a cell phone, pager, personal digital assistant, laptop, palmtop, sub-notebook, or wearable computer.
